(19) United States
(12) Patent Application Publication
(10) Pub. No.: US 2020/0202420 A1
(43) Pub. Date: Jun. 25, 2020

(54) WEB AND APP BASED REAL ESTATE PLATFORM

(71) Applicant: Jesse Van Dyke, Chicago, IL (US)

(72) Inventor: Jesse Van Dyke, Chicago, IL (US)

(21) Appl. No.: 16/724,022

(22) Filed: Dec. 20, 2019

Related U.S. Application Data
(60) Provisional application No. 62/783,083, filed on Dec. 20, 2018.

(51) Int. Cl. G06Q 30/06; G06Q 50/16

(52) U.S. Cl. CPC G06Q 30/0645; G06Q 50/167; G06Q 30/0619

(57) ABSTRACT

A computer implemented method and a system matches a prospective tenant with a real estate property owned by a landlord or managed by a property management company or realtor, at least in part based on a space requirement calculation. The method includes: allowing a user, by a computer, to evaluate the amount of space required for a real state property; allowing a user, by a computer, to search for the real estate property; scheduling, using input data of a user, by a computer, a tour of the real estate property; negotiating, using the input data of a user, by a computer, for a space with input from a computer; agreeing, by a computer to the terms; and finalizing, by a computer, a lease for the lease.

### RELATED APPLICATIONS

This application claims priority to U.S. Provisional Application Serial No. 62/783,083 filed Dec. 20, 2018, which is incorporated by reference in its entirety herein.

### BACKGROUND

### 1. Field of the Disclosure

The present disclosure relates to real state web applications, and more specifically, to systems, apparatus, and methods for evaluating, touring, and matching a tenant to a property.

2. Description of Related Art

Finding a home, apartment, or establishment for rent can be a stressful and difficult undertaking. Attempting to check the local classified ads, noting the “For Sale” signs when out and about, and trying to find information from friends and realtors is very time consuming and inefficient. There are also a lot of applications on the market that allow users to find a place for rent. However, once the user finds a place that he/she likes, the user still has to interact with realtors, make tour appointments, and finalize the lease or sale. A lot of time may be wasted attempting to schedule tours, trying to coordinate meetings, and negotiating a lease with realtors and owners.

### SUMMARY

In one example according to the teachings of the disclosure, a web or app based real estate system or platform comprises a processor and a memory coupled therewith. The system further includes a computer executable program code stored in the memory and executable by the processor to generate: a tenant module to allow a user to sign up for a real estate service and/or to perform a search of the real estate property; a space search module to perform a search of a real estate property, a touring module to schedule a tour and/or to perform a tour; a negotiation module to negotiate a proposal; a landlord module; and a space requirements calculation module, executed by the processor. The space requirements calculation module allows the user to enter default settings data for a space. The processor further generates a user interface that includes: a tenant interface that is executed by the processor and controlled by a prospective tenant for allowing the prospective tenant to connect to the tenant module and thereby enter tenant information into the tenant module; a landlord interface, executed by the processor, controlled by a landlord for connecting to the landlord module and thereby identify the real property and identify the real estate property based on space characteristics; and a broker interface, executed by the processor, controlled by a broker for connecting to the broker module. The space requirements calculation module calculates a general square foot number based upon data to determine how much space to search for.

In another example, the system may be configured for matching a prospective tenant with a real estate property owned by a landlord, or managed by a property management company or realtor, at least in part based on a space requirement calculation.

In another example, the matching may be further based on geographic location and price based upon data entered by the user for a space.

In another example, the user interface may be displayed in a web browser.

In another example according to the teachings of the present disclosure, a computer implemented method is configured for matching a prospective tenant with a real estate property from a plurality of real estate properties, each owned by a landlord or managed by a property management company or realtor. The method includes: signing up for a real estate service; performing a space requirements calculation; performing a space search; setting up a tour of one or more of the plurality of real estate properties; performing the tour of the one or more real estate properties; and negotiating a proposal for at least one of the one or more real estate properties. Each of these steps may be performed via a computer or a processor.

In another example, the negotiating may include: sending a request for the proposal; receiving a proposal from the corresponding landlord; and sending a counter proposal. Each of these steps may be performed via a computer or a processor.

In another example, the negotiating may further include receiving a counter proposal and submitting a revised offer. Each of these steps may be performed via a computer or a processor.

In another example, the method may further include agreeing to terms of a lease. This step may be performed via a computer or a processor.

In another example according to the teachings of the present disclosure, a computer implemented method matches a prospective tenant with a real estate property owned by a landlord or managed by a property management company or realtor, at least in part based on a space requirement calculation. The method includes: allowing a user, by a computer, to evaluate the amount of space required for a real state property; allowing a user, by a computer, to search for the real estate property; scheduling, using input data of a user, by a computer, a tour of the real estate property; negotiating, using the input data of a user, by a computer, for a space with input from a computer; agreeing, by a computer to the terms; and finalizing, by a computer, a lease for the lease.

In another example according to the teachings of the present disclosure, a method implemented by a computer system for web-based interaction matches a prospective tenant with a real estate property from a plurality of real estate properties. The method includes: creating, by a processor of the computer system, a real estate database of information related to the plurality of real estate properties, the database created from information acquired from a landlord, the information including real estate data for the plurality of real estate properties; displaying, by a processor of the computer system via a user interface presented to the user on a display coupled to a client computer, a display of real estate parameters; receiving, from the client computer, an input data of the real estate parameters provided by the user via the user interface indicating a request for real estate information; performing, by the processor, a space requirements calculation based on the input data; performing, by the processor, a space search on the real estate database based on the space requirements calculation; displaying, by the processor, via the user interface, a display of a subset of the plurality of real estate properties that match the space search; setting up the tour of real estate properties; and negotiating a proposal.

In another example, the setting up the tour of real estate properties may include: receiving, from the client computer, user input data indicating a request for the tour; requesting, from a landlord, landlord input data indicating acceptance of the request of the tour; creating, by the processor, a tour data display using the data input by the landlord; sending, by the processor, the tour data display to the client computer that requested the tour data display; displaying, by the processor, the tour data display.

In another example, the negotiating the proposal may include: receiving, from the client computer, user input data indicating the request for the proposal; requesting, from a landlord, landlord input data indicating the terms of the proposal; displaying, by the processor, the terms of the proposal display; receiving, from the client computer, user input data indicating a counter proposal; and requesting, from a landlord, landlord input data indicating acceptance to the terms of the counter proposal

### BRIEF DESCRIPTION OF THE DRAWINGS

Objects, features, and advantages of the present invention should become apparent upon reading the following description in conjunction with the drawing figures, in which:

FIG. 1 illustrates a real estate matching and communication system in accordance with one example.

FIG. 2 illustrates a framework for implementing the real estate matching and communication system in accordance with one example.

FIG. 3 shows an illustrative example of a general computer or server for use with the system of FIGS. 1 and 2.

FIG. 4 illustrates a sample welcome screen display in accordance with one example.

FIGS. 5-13 illustrate a space requirements calculation module sample screen display sequence in accordance with one example.

FIGS. 14-18 illustrate tour module sample screen displays in accordance with one example.

FIGS. 19-31 illustrate a negotiation module sample screen displays in accordance with one example.

FIG. 32 shows a comparison between the Traditional Real Estate Process and the new Platform Process

### DETAILED DESCRIPTION OF THE DISCLOSURE

The present disclosure includes an application platform for integrated commercial real estate evaluation, tour scheduling, site selection, financial modeling, negotiation, and lease process activities. The present disclosure includes an integrated commercial real estate evaluation platform that uses a web/online and application-based tool. The platform serves as an intermediary between the parties and trades and supplies information between at least two parties, including a user and a landlord, in order to facilitate a transaction.

The disclosed system provides a start to finish real estate platform that allows a user to evaluate the amount of space required, search for space, schedule tour of spaces, evaluate the spaces, negotiate for space with input from the platform, negotiate the financial and non-financial terms of the spaces, agree to terms, and finalize a lease. The disclosed system allows users, owners and agents to more efficiently complete the leasing process of a real estate property from start to finish in real time.

A user refers to a tenant or company searching for an office, industrial, retail or commercial space. A user agent or user broker represents the interests of the user. A user agent may or may not be involved in the process of using the platform on behalf of the user. A user agent may complete the process within the platform on behalf of user. An owner refers to the owner of the building or property. An owner agent represents the interests of the owner. The owner agent may or may not be involved in the process of using the system on behalf of the owner. The owner agent may complete the process within the platform on behalf of the owner. A landlord refers to a building owner or an owner agent of the property in which the user is interested. A broker refers to an intermediary between the user and the landlord, as is known in the art, and may be neutral or may be a user broker or a landlord broker. A third party may refer to attorneys for the user and the owner, the architects for the user or the owner, the contractors for the user or the owner, and the consultants for the user or the owner.

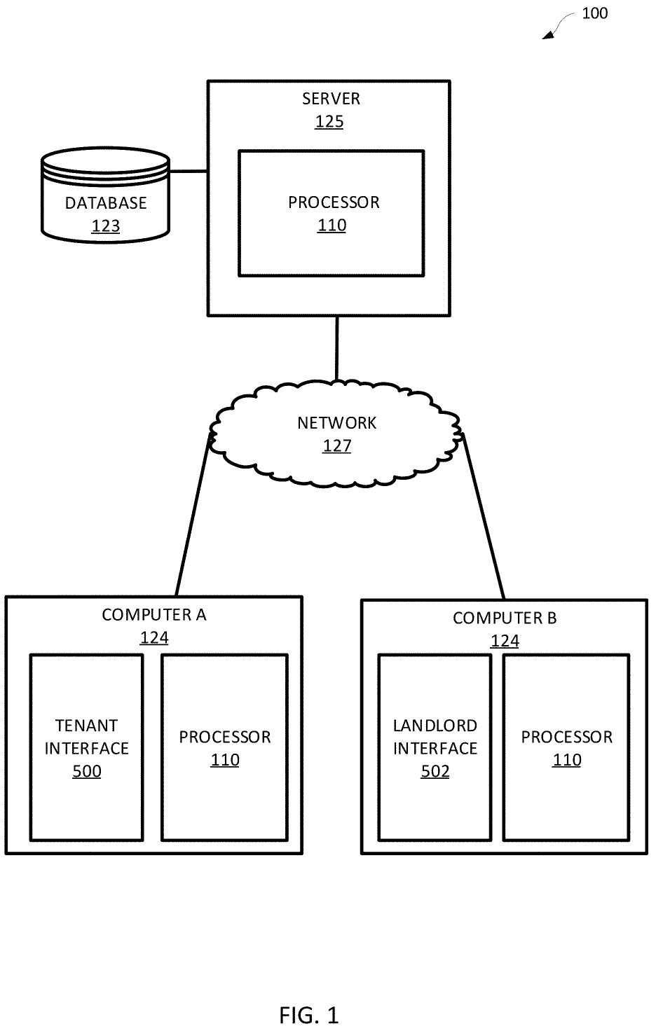

FIG. 1 illustrates a computer system 100 for real estate matching and communication in accordance with one example. The system 100 may also be referred to as the platform. The system 100 includes one or more server(s) 125, e.g., a real estate server. The server 125 may include a real estate controller or processor 110 and a network 127. A system 100 may include the server 125 and a database 123. The database 123 may be a real estate database including real estate data and a geographical database including satellite map images of the real estate properties. The real estate data may include real estate property addresses, type of building, type of space, amenities, property and space characteristics, photos, multimedia, neighborhood information, and the like. The system 100 may include computer systems and networks of a real estate system operator. A computer 124 or a computer device or mobile device (or multiples thereof), collect the user data and the server 125 performs the following algorithms on the real estate data. Alternatively, the computer 124 may perform the algorithms on the real estate data. One or more computers 124 may be directly connected to the server 125. The server 125 and the database 123 exchange (e.g., receive and send) data with the computers 124. Additional, different, or fewer components may be included or utilized.

The server 125 may be a host for a website or web service such as a real estate service and a mapping service. The mapping service may provide maps generated from the geographic data of the database 123. A navigation service may generate routing or other directions from the geographic data of the database 123. The mapping service may also provide information generated from attribute data included in the database 123. The server 125 may also provide historical, future, recent, or current real estate information.

The system 100 allows one or more users to submit, request and view data over the network 127. The network 127 may be a wide area network (WAN) such as the Internet. The Internet is a global system of interconnected computer networks that use the Internet protocol suite (TCP/IP) to link devices worldwide.

The computers 124 may be a smartphone, tablet, personal computer, laptop computer. The computers 124 may be coupled to a controller or processor 110.

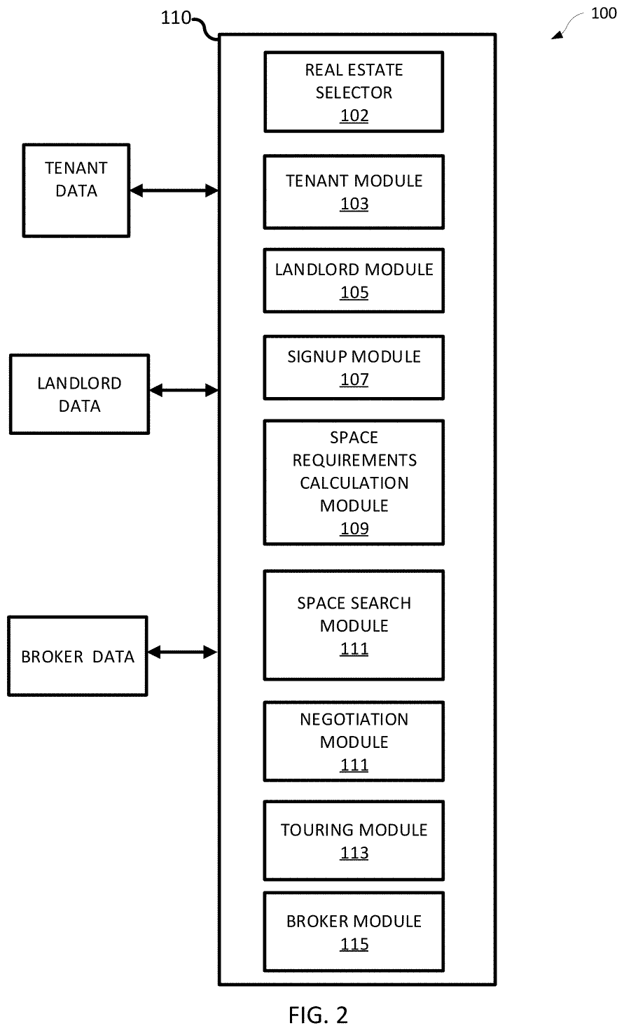

FIG. 2 illustrates an example framework for implementing the real estate matching and communication system. The real estate matching and communication system may include a controller or processor 110 including any combination of a real estate selector 102, a tenant module 103, a landlord module 105, a sign-up module 107, a space requirements calculation module 109, a space search module 111, a negotiation module 111, a touring module 113, and a broker module 115. The processor 110 may be implemented by either the computer 124 or the server 125. In some examples, portions of the framework in FIG. 2 may be implemented by the server 125 and other portions may be implemented by the computer 124. Additional, different, or fewer components may be included or utilized.

The real estate system or platform 100 includes a sign-up module 107 that allows a user to sign up to start using the service. The user signs up via a website or app download. The user provides basic information in order to be granted access to the platform such as their name, email address, and/or phone number. The user may be asked to click through a terms and conditions agreement to gain access. Within the terms and conditions, there may be language that denotes the platform as the recognized broker of record in that state or country for purposes of collecting a commission should the user conclude or be introduced to the desired space by the platform.

The user's data may be saved in a database 123. Once the user has been granted access to the platform, the user can utilize the platform in order to facilitate the leasing transaction.

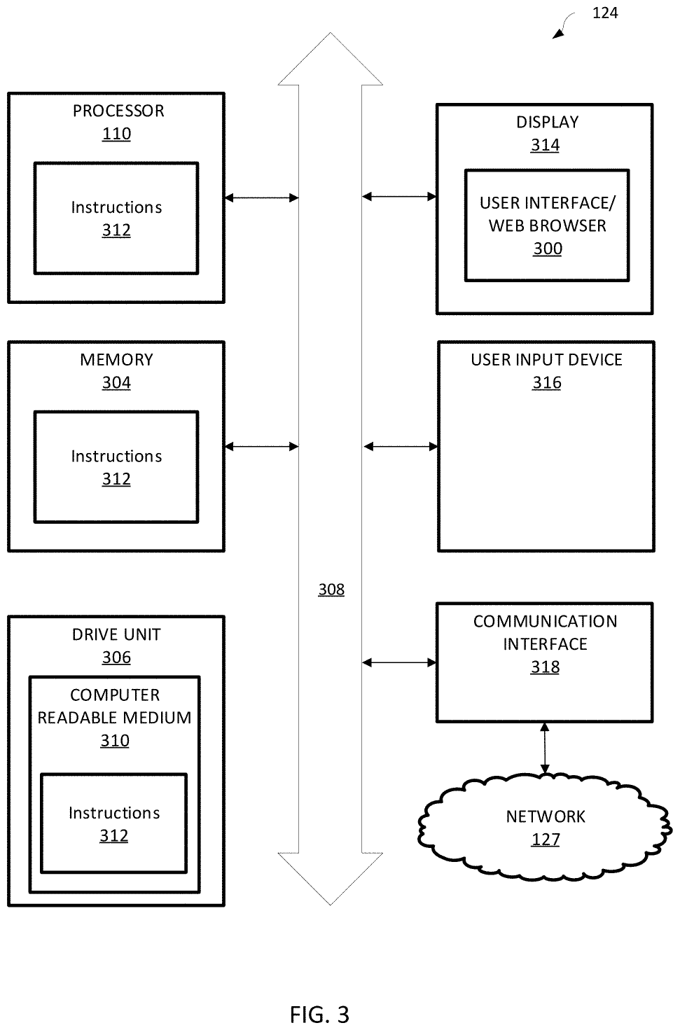

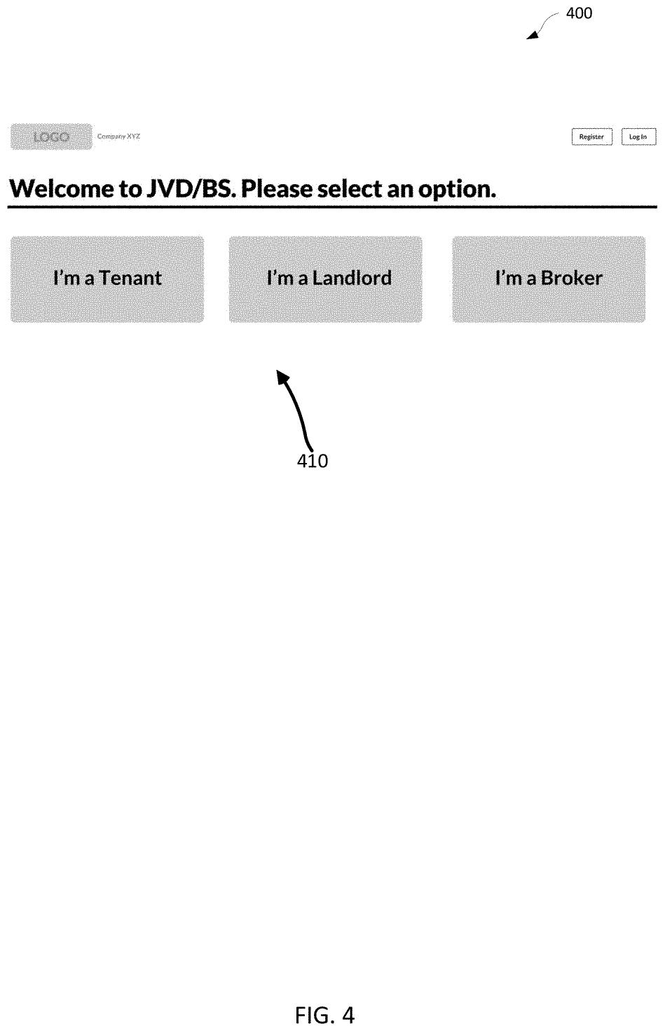

FIGS. 4-31 illustrate various aspects of a platform interface 300, which may include a welcome interface 400, a tenant window or a tenant interface 500, and a landlord interface 502. The tenant window interface may include a map location interface 600, a budget interface 900, and a timeframe interface 1000 for allowing a user to enter, submit and view real-estate property data. The platform interface 300 is meant to be displayed on a computer display 314, as described below with respect to FIG. 3, coupled with the client device/computer 124. The disclosed examples presented herein may be implemented by any type of display, now available or later developed including touch screen displays, mobile device displays, virtual reality displays, and the like. Furthermore, interaction with the interface 300 may be accomplished with any one or more user interface devices, or combinations of devices, now available or later developed, such as the user input devices 316, as described below with respect to FIG. 3, coupled with the client device/computer 124, such as keyboards, mice, touch screens, virtual reality input devices, eye tracking devices, etc. or other devices designed to translate user intention into data inputs to the device.

FIG. 4 illustrates a sample screen display showing a welcome user interface 400 according to one embodiment. The welcome user interface 400 has a section 410, which provides a first set of “buttons” that allows the user to choose whether to use the tenant, landlord, or the broker module. Once the appropriate button is chosen and utilized, the user may be directed to the relevant portion of the system for that type of user.

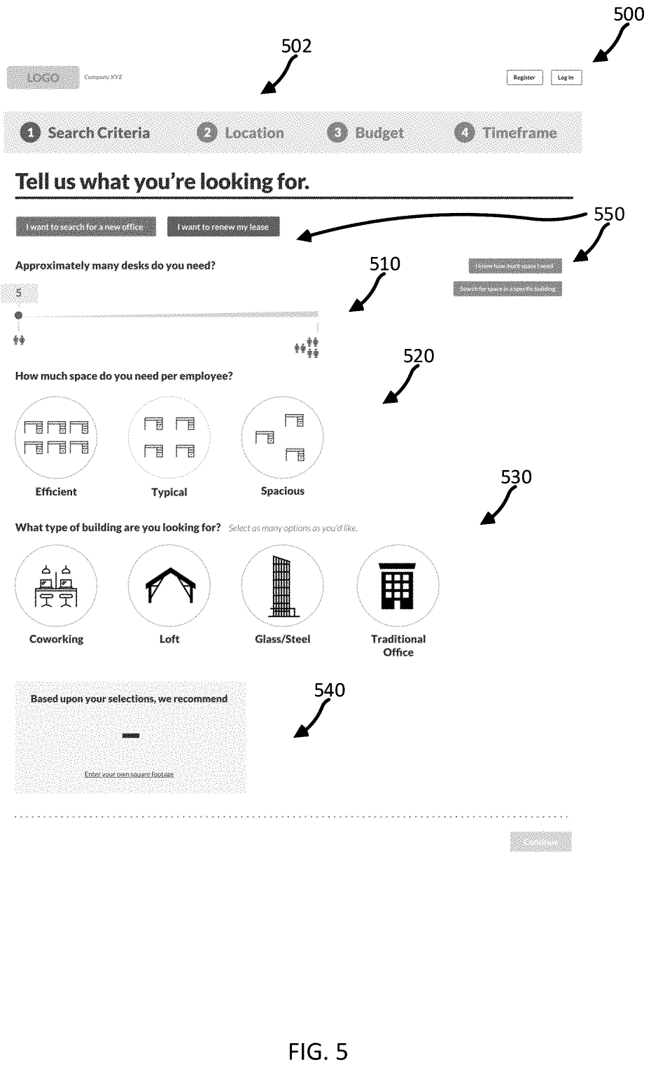

FIGS. 5-13 illustrate a space requirements calculation module sample screen display sequence displayed on the tenant interface 500 according to one example. The space requirements calculation module allows the user to enter data necessary to perform the space calculations. The space calculations are used to find the correct space to match the needs of the user.

FIG. 5 shows an example of the tenant interface 500 displayed when the user chooses the tenant module 103. The user may use the tenant interface 500 to input requested data to be used to search for the real estate property. The requested user data is used to determine how much office, retail, or industrial space is needed. The space requirements calculation module requests the user to enter selection data information. The selection data information may include: the number of employees, desks or seats; the amount of space needed per employee; and the type of building needed. The tenant interface 500 may include a first section 510, which provides interactive controls to allow a user to set quantities for employees via a slider. In an example, the user may use a slider to input the number of desks that are needed. The tenant interface 500 may also include a second section 520 ,which provides a second set of “buttons” to allow a user to choose a type of space among a plurality of types of spaces. The plurality of types of spaces may include but are not limited to “Efficient”, “Typical” or “Average”, and “Spacious”. The tenant interface 500 may also include a third section 530, which provides a third set of “buttons” to allow a user to choose one of a plurality of types of buildings. The plurality of types of buildings may include but are not limited to “Coworking”, “Loft”, “Glass/Steel”, and “Traditional Office”. The tenant interface 500 may also provide a fourth section 550, which provides a fourth set of “buttons” to allow the user to begin a search for a new space, to renew an existing lease, to specify how much space is needed, or to search for a space in a specific building.

The space requirements calculation module calculates a general square feet number based upon data to determine how much space the user might require and for which the platform may need to search.

In an example, the space requirements calculation module 109 assumes the ranges listed below. Other ranges may also be included.
Efficient=1 employee per 90 rentable square feet
Typical or Average=1 employee per 125 rentable square feet
Spacious=1 employee per 225 rentable square feet

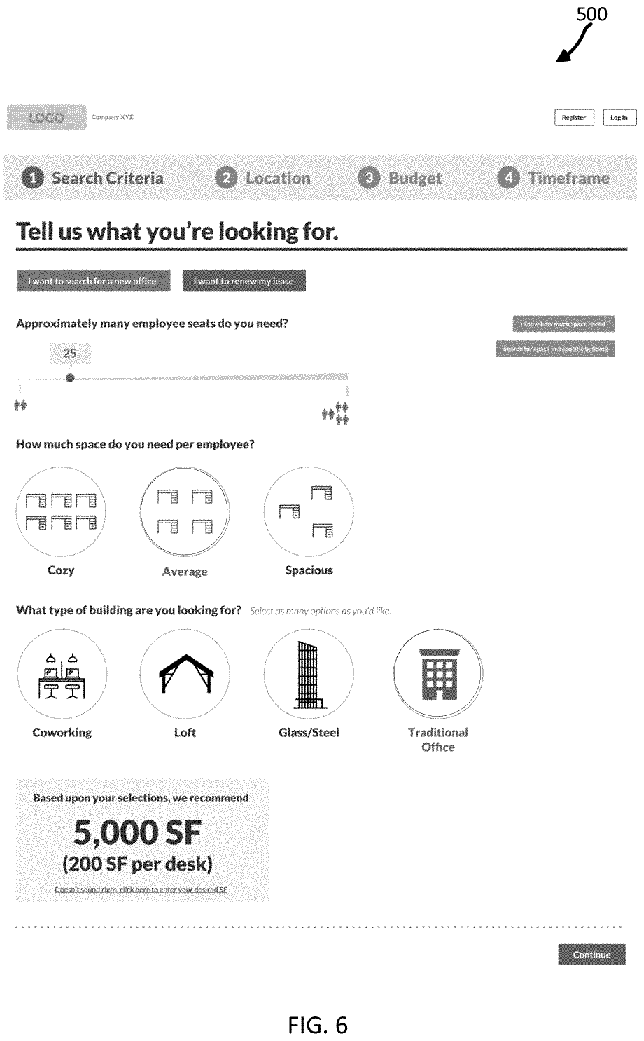

FIG. 6 shows the tenant interface 500 according to one example. In this example, the user inputs 25 employees, an “Average” space, and a “Traditional Office” as the selection data. The space requirements calculation module uses the data entered by the user to perform the space calculations and determines that a space of 5,000 square feet is recommended. In other words, the requirements calculation module 109 uses the number of employees, the type of space and the type of building needed in order to recommend a size of space.

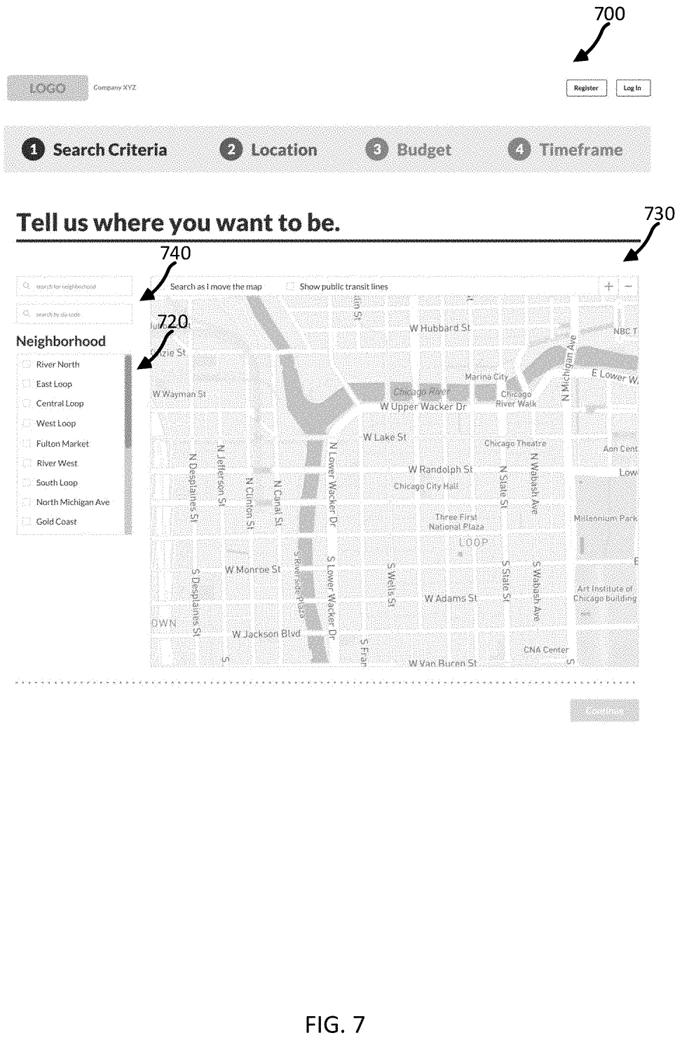

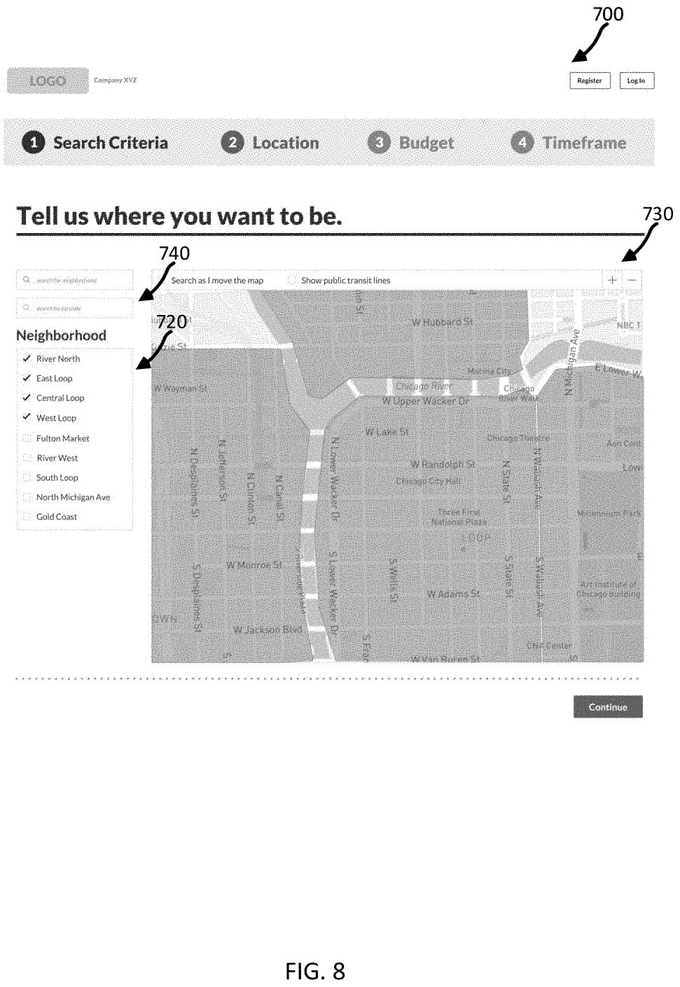

FIGS. 7 and 8 show a map location interface 700 according to one example. The space requirements calculation module 109 may ask the user to select a location on the map of where they would like their property located. The map location interface 700 may include a first section 720 that provides interactive controls to allow the user to select one or more locations. The map location interface 700 may include a map 730 to display the available locations. The map location interface 700 may include a second section 740 that allows the user to enter text to search by a neighborhood name or by a zip code. FIG. 8 shows an example of the map interface 700 in which the user has selected the “River North”, “East Loop”, “Central Loop”, and “West Loop” locations.

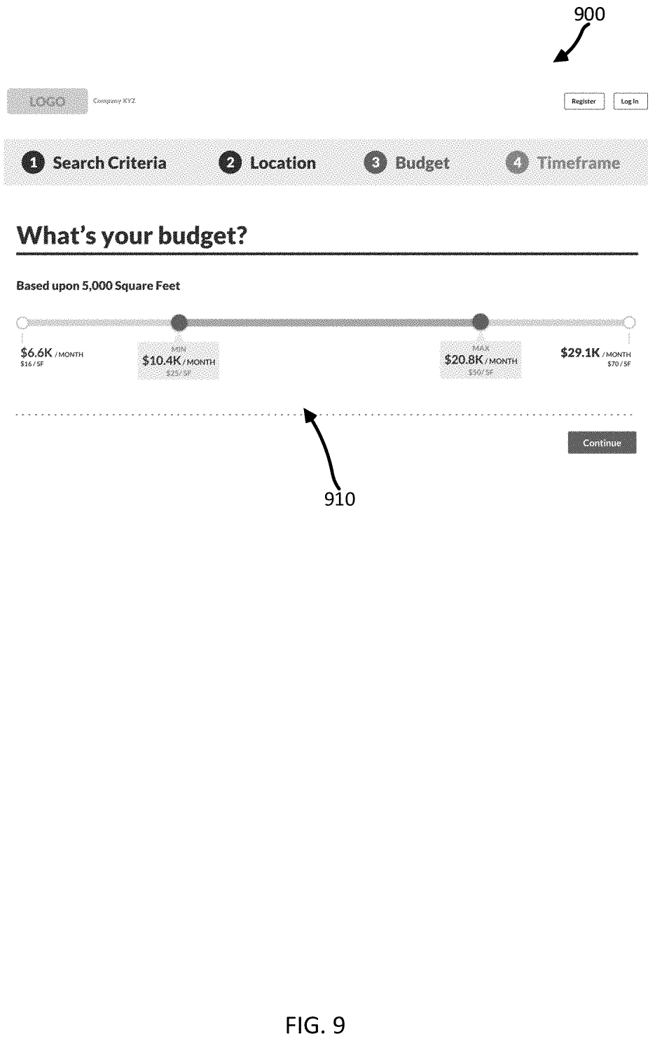

FIG. 9 shows a budget interface 900 according to one example. The space requirements calculation module may show the user an upper and lower budget range based upon the areas and size of space at which the user will likely be looking. The budget interface 900 may include interactive controls 910 to allow the user to choose a preferred budget range within the limits mentioned above.

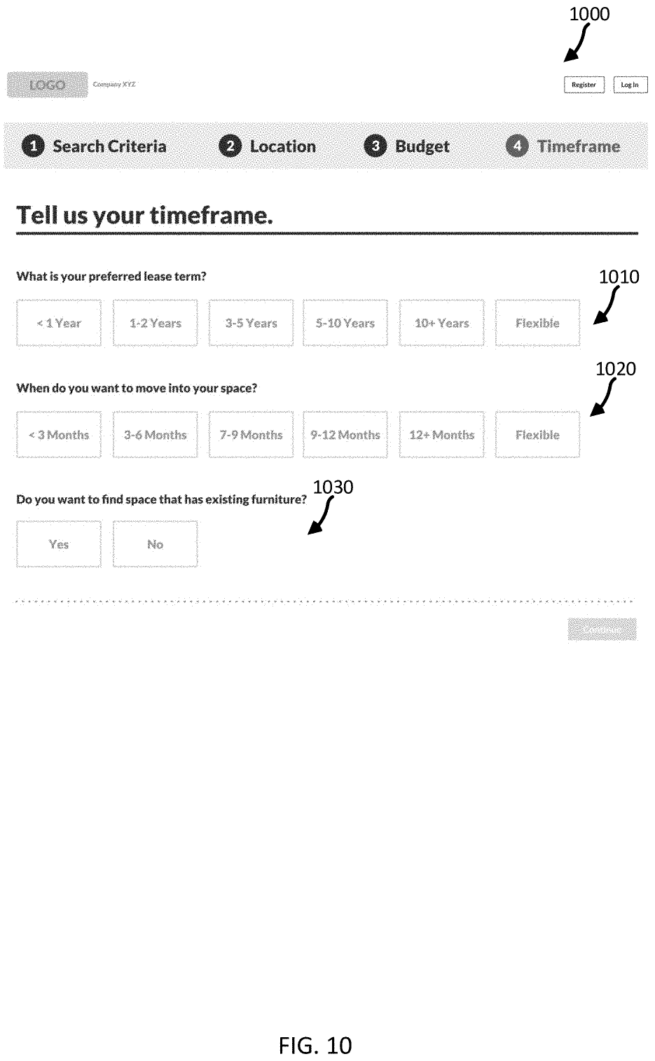

FIGS. 10 shows a timeframe interface 1000 according to one example. The space requirements calculation may ask how long of a lease term the user would like to commit. The space requirements calculation module may ask the user when they would like to move into the space. The space requirements calculation module 109 may ask the user if they have furniture or need to find a space that has furniture. The timeframe interface 1000 may include buttons 1010 to allow the user to specify how long of a lease term the user would like to commit. The timeframe interface 1000 may also include buttons 1020 to allow the user to specify when they would like to move into the space. The timeframe 1000 may further include buttons 1030 to allow the user to specify whether they would like to find a space that has existing furniture.

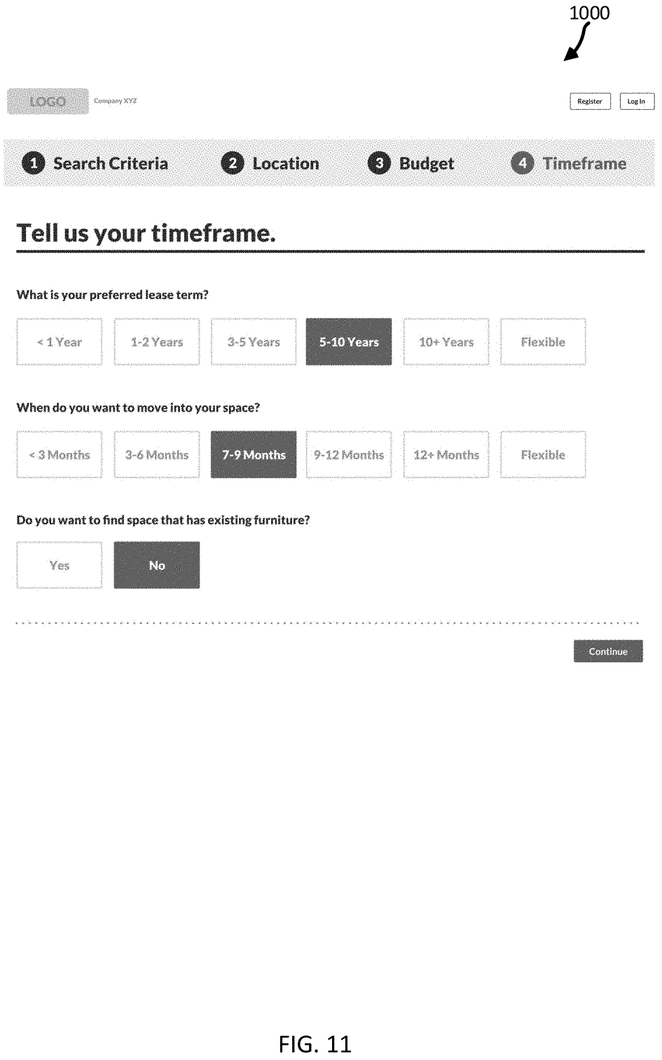

FIG. 11 shows a timeframe interface 1000 according to one example in which the user has selected a term of 5-10 years and a moving time of 7-9 months. In this example the user has selected that he/she does not need furniture.

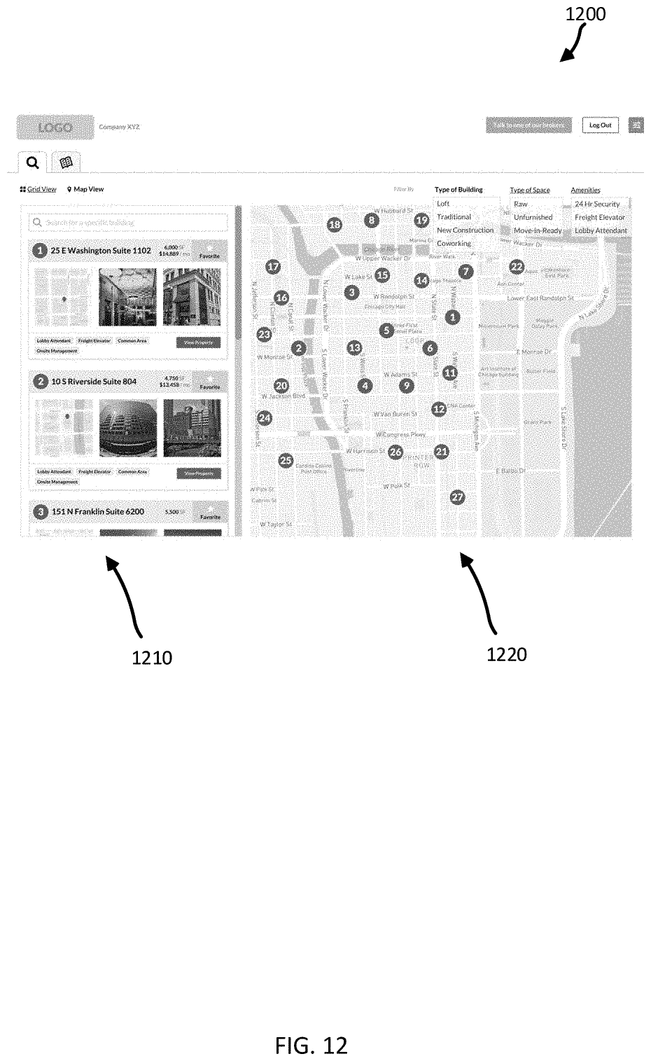

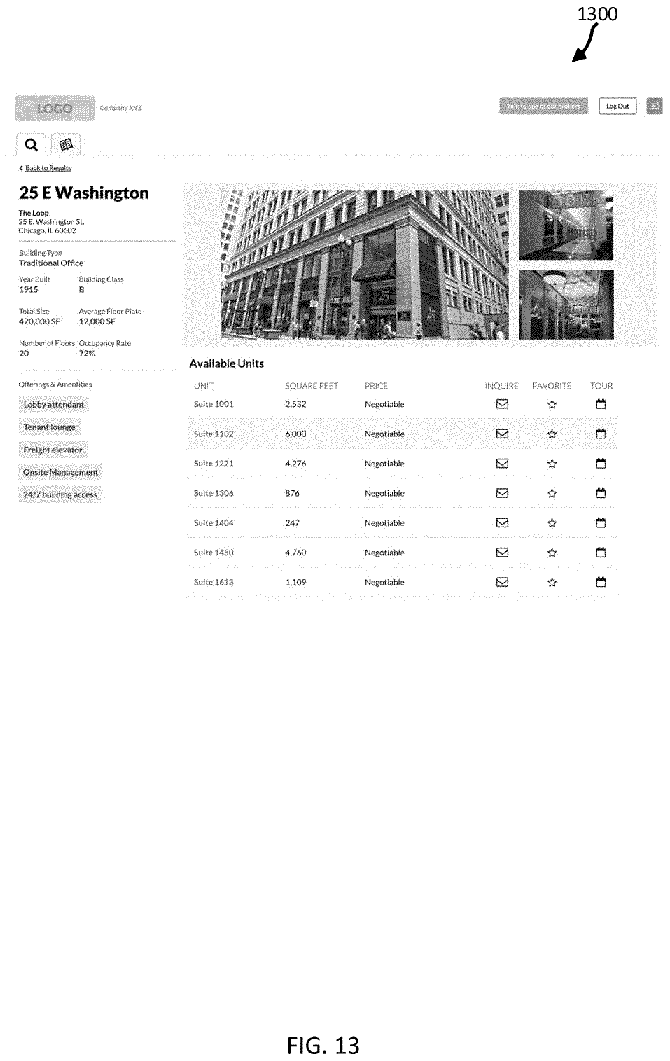

FIGS. 12 and 13 illustrate space search screen displays according to one example. The system 100 may use the information that the user has input to determine the best matches for offices. The system 100 may display the user the search results. FIG. 12 illustrates a space search interface 1200. The space search interface 1200 may include section 1210, which allows the user to see a list of the results in a grid view and may include section 1220, which allows the user to see the list of the results in a map view. The space search interface 1200 may allow the user to evaluate the results and select different buildings and spaces about which to learn more detail. FIG. 13 shows a detail interface 1300, which allows the user to view detailed information about the chosen property. After reviewing the results in detail, the user may select their “Favorites” and may take further steps within the platform.

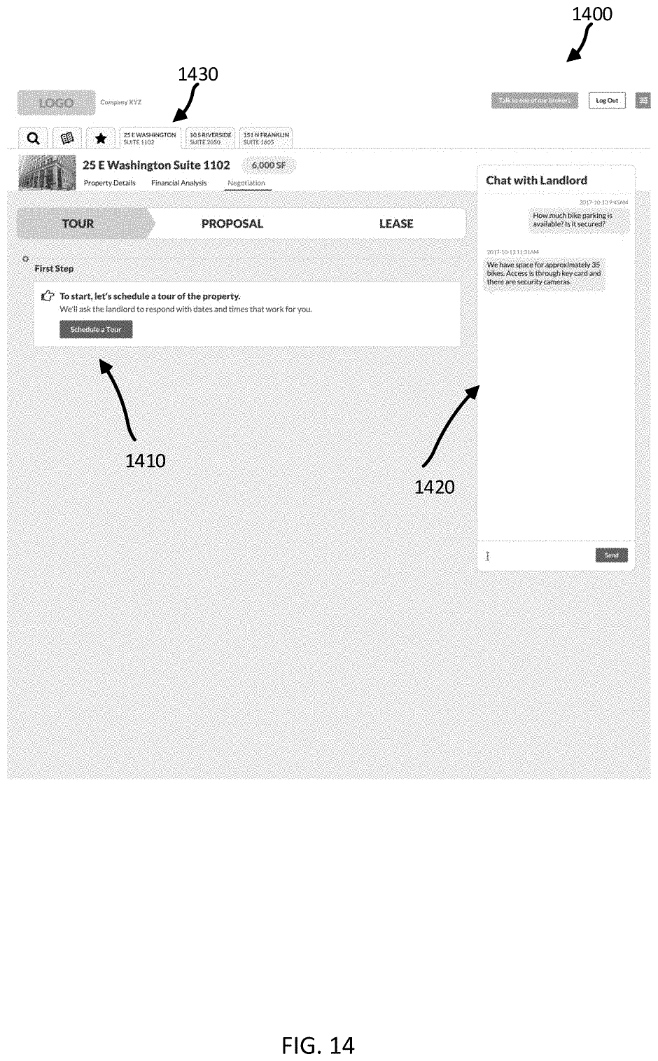

FIGS. 14-18 illustrate tour module screen displays according to one example. The tour module may allow the user to select properties of interest to tour.

FIG. 14 shows a tour interface 1400 according to one example. The user may now choose to schedule a tour to see one or more properties. The tour interface 1400 may include: a button 1410 that allows the user to tour the chosen property; a section 1420 that allows the user to chat with the landlord; and a section 1430 that provides different tabs to access the “favorite” real estate properties.

The user may be able to contact the landlord of the buildings directly, using the tour module, to schedule a tour of the properties of interest.

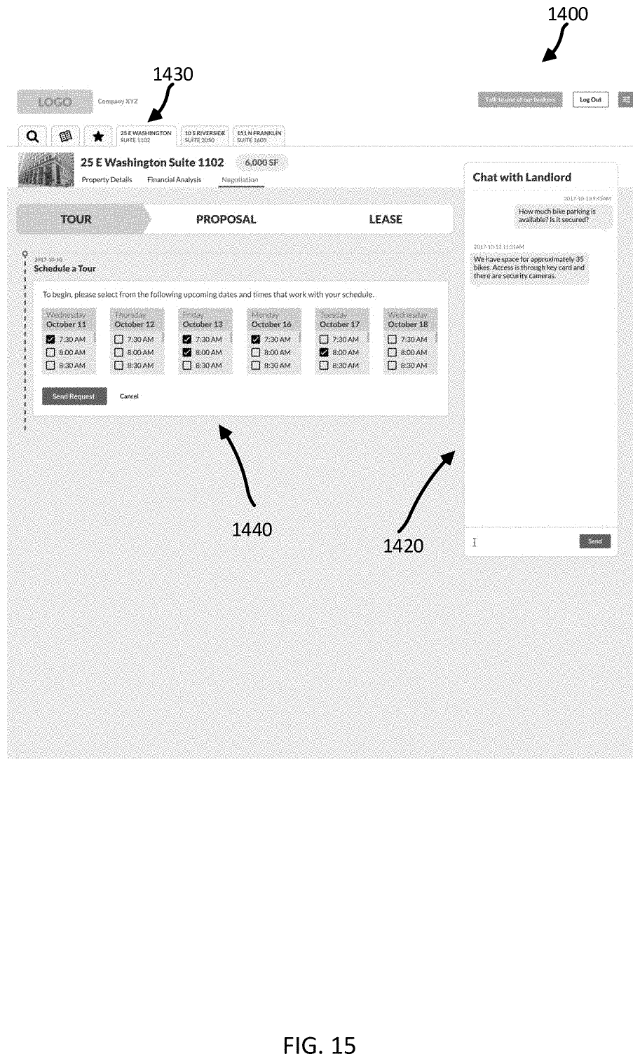

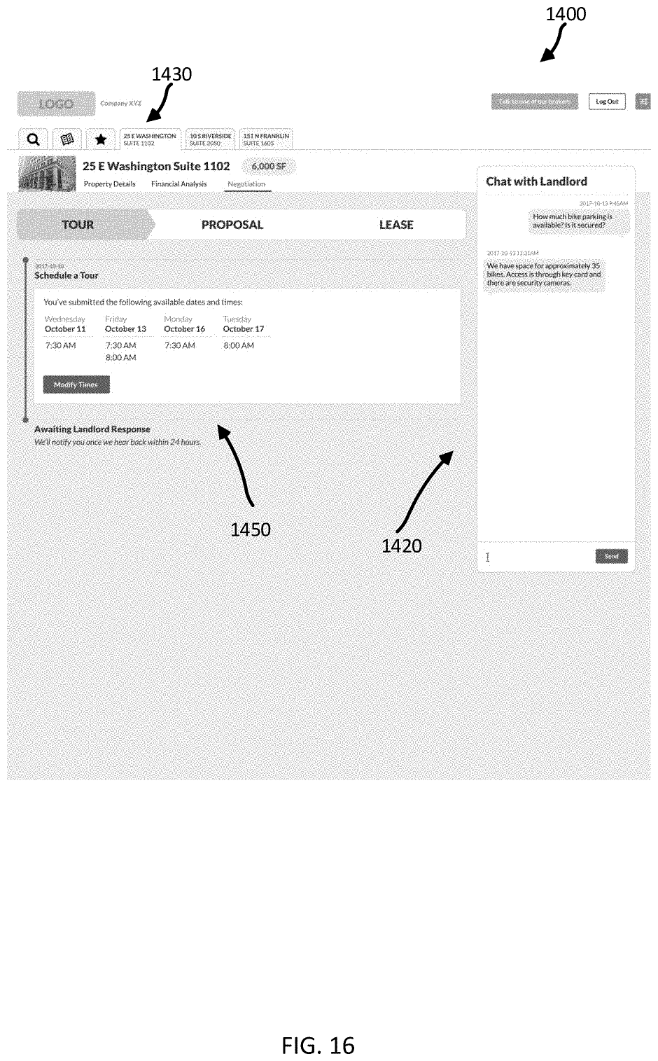

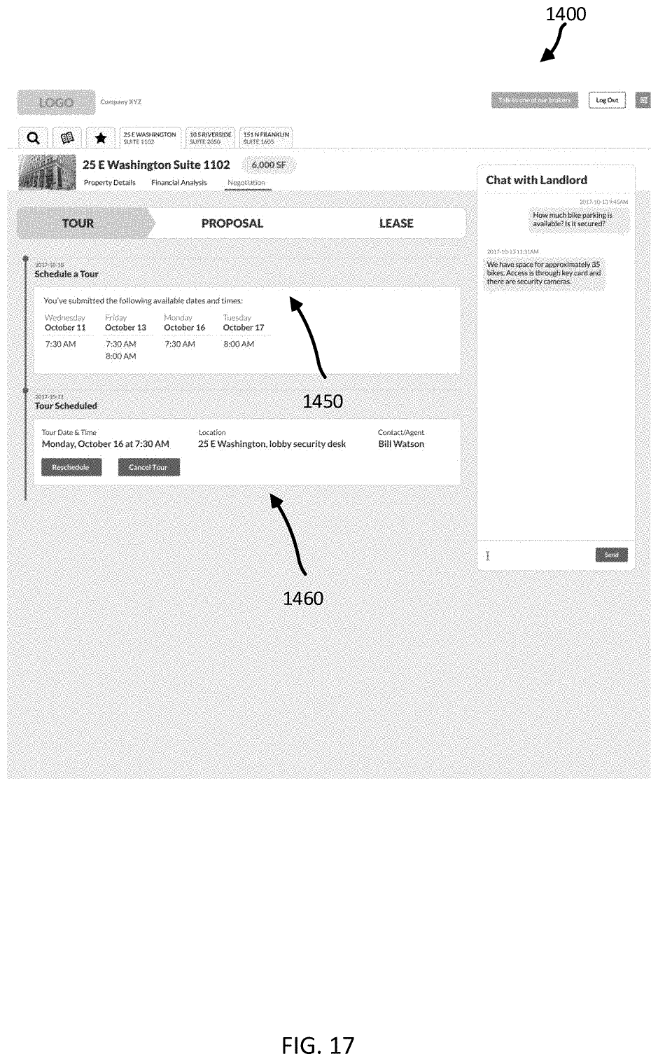

FIG. 15 shows a tour interface 1400 in accordance with one example. In this example, the tour interface 1400 may include a section 1440 that provides the user with a list of available times that the selected buildings can show the space. The user may select the times that work and may request the tour using the tour module. The tour module may send the requests to the landlord and the landlord can accept or reject the tours. FIG. 16 shows the tour interface 1400 according to an example. In this example, the tour interface 1400 may include a section 1450, which shows a list of the requested times for the tour. The status of the request, i.e., whether the landlord has accepted or not, may also be shown. The tour module may receive confirmation from the building and then the tours are scheduled. The tour module may notify the user that a tour is scheduled. FIG. 17 shows the tour interface 1400 according to an example. In this example, the tour interface 1400 may further include section 1460, which displays the scheduled tour information.

If the owner approves the tour with the user, the platform may be automatically recorded as the broker of record. The platform will be owed a commission if the user signs a lease at the toured property.

When the platform receives a confirmation from the landlord, the tours may be scheduled by sending an automated calendar invite to the user. In an example, the calendar invite might be received in the computer or smartphone.

The processor 110 may automatically determine a building tour order based upon the most efficient geographical route or shortest point to point distances.

The user may tour the properties and may use the touring module to communicate if they are running early or late. The user may view the different spaces using the touring module and may be able to take pictures, video, and/or notes of the spaces, which may be stored in the platform, such as within the tour module. The user may finish the tour and may be able to review any pictures, video, and/or notes.

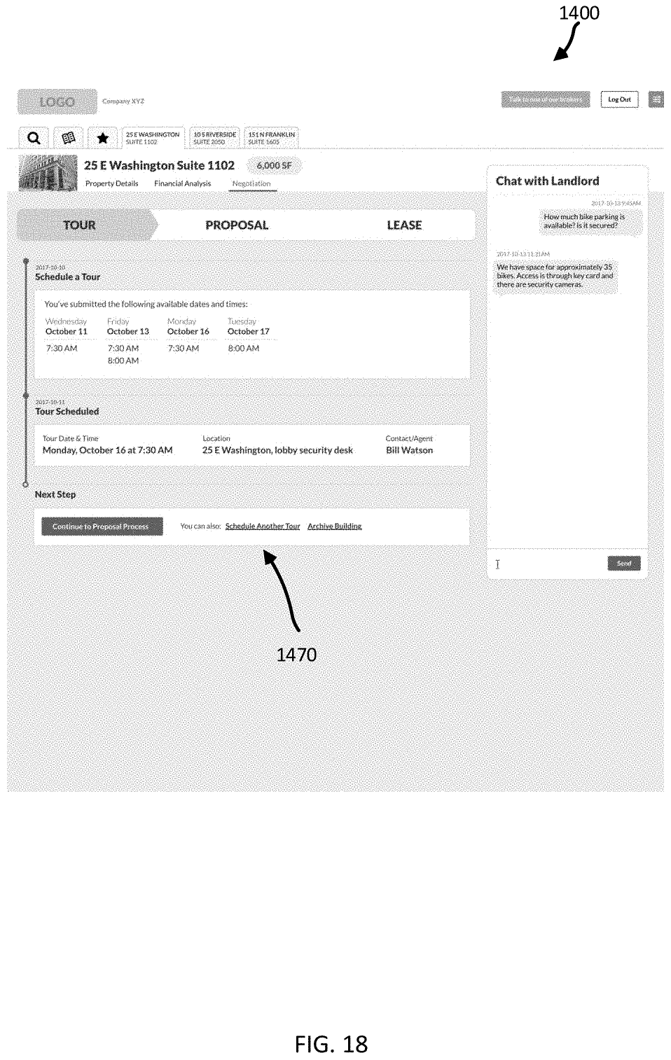

FIG. 18 shows the tour interface 1400 according to one example. In this example, the tour interface 1400 may include a section 1470 that provides buttons, which allow the user to continue to the proposal/negotiation process, to schedule another tour, or to archive the building.

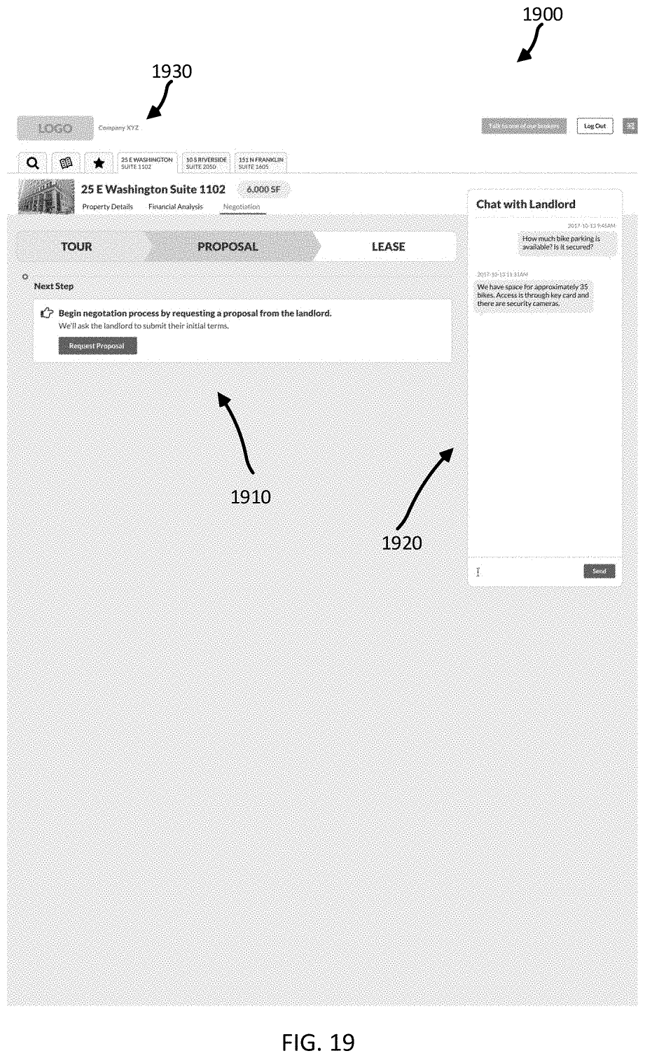

FIGS. 19-27 illustrate negotiation module screen displays according to one example. The negotiation module may allow a user to send a request for a proposal. The negotiation module may also allow the user to negotiate the lease terms at the buildings of the user's choice. The negotiation module may allow the user to be able to request a proposal from the buildings of their choice. The negotiation module may show the user what the proposal request will contain. Items may include: rentable square feet of suite, lease term/length, lease commencement date, rent per square foot, lease type (net or gross), rent increase per year, tax and operating cost per square foot, gross rent abatement offered, construction of suite, furniture provided, tenant improvement allowance, and/or the like. The negotiation module may contact the landlord/building and may notify the, of the proposal request by the platform. The user may be shown how much money they may be saving by using the system 100 over a traditional broker.

The negotiation module may receive the proposals from the buildings. The landlord may submit terms for the user to consider through the platform for a given building. The user may view the terms of what the landlord sends. The terms may again include: rentable square feet of suite, lease term/length, lease commencement date, rent per square foot, gross rent abatement offered, construction of suite, furniture provided, tenant improvement allowance, and/or the like. The system 100 may automatically complete a financial analysis using the terms that the landlord had sent to the system 100. The user may view the financial analysis. The system 100, using proprietary market data, transaction history, and/or other sources, may recommend to the user that they should send a counter proposal to the landlord. The system 100 may also recommend to the user different outside vendors that can assist the user with the project, such as an architect, a contractor, and/or the like. The user may have the ability to submit a counter proposal through the platform to the landlord.

FIGS. 19-31 illustrate the negotiation module screen display according to one example. The negotiation module may allow the user to send a counter proposal. The system may recommend counter proposal terms to the user, relying on proprietary market data, transaction history, and/or other sources. The user may accept the system recommendations or alter the recommendations prior to submitting a counter proposal back to the landlord. The platform may not allow a user to submit counter proposal terms that are significantly different than existing market terms. The user then may send a counter proposal to the landlord using the platform. Upon submission, the user may be able to review the changes that have been submitted to the landlord and modify, if and as needed.

The negotiation module may allow the landlord to receive a counter proposal. The landlord may receive the counter proposal and may be able to review the terms using the system 100. The landlord may accept the terms or may propose new terms using the platform.

The negotiation module may allow the landlord to submit a revised offer. The landlord may submit the revised offer to the user through the system 100. The user may then evaluate the revised offer via the platform. The platform may allow the user to once again evaluate the financial analysis calculated by the platform. The platform may then recommend submitting a counter proposal or accepting the terms that the landlord has submitted through the platform. The user may elect to move forward or to cease discussions with the landlord.

The back and forth negotiation through the platform may continue until the parties agrees to the terms or they agree to cease negotiations.

The negotiation module may allow the user to agree to terms of a lease. The user may agree to terms submitted by the landlord through the platform. The user may elect to accept the proposal and to move to the next step. The landlord may be notified that the user has accepted the terms. The landlord may then begin drafting a lease based upon the terms that have been agreed upon during the negotiation using the platform. The landlord may upload the lease to the platform. The user may then share the lease with an attorney or broker, print the lease, accept and sign the lease, and/or decline the lease. Upon reviewing the lease, the user may then upload a revised lease to the platform for the landlord and the landlord's attorney or broker to review. The landlord may then review the modified lease that has been uploaded by the user in the platform. The landlord and the user may go back and forth until the lease and its terms are finalized. Upon agreement of the lease by both the user and the landlord, both may receive a notification that the final version is available on the platform. The platform may then recommend various vendors to the user, such as moving companies, telephone and/or data providers, contractors, furniture providers, etc.

FIG. 19 shows a negotiation interface 1900 according to one example. In this example, the negotiation interface 1900 may include: a button 1910 that allows the user to send a request for a proposal; a section 1920 that allows the user to chat with the landlord; and a section 1930 that provides different tabs to access the “favorite” real estate properties. The user's name may not be communicated to the landlord, though the calculated recommended size space may be sent.

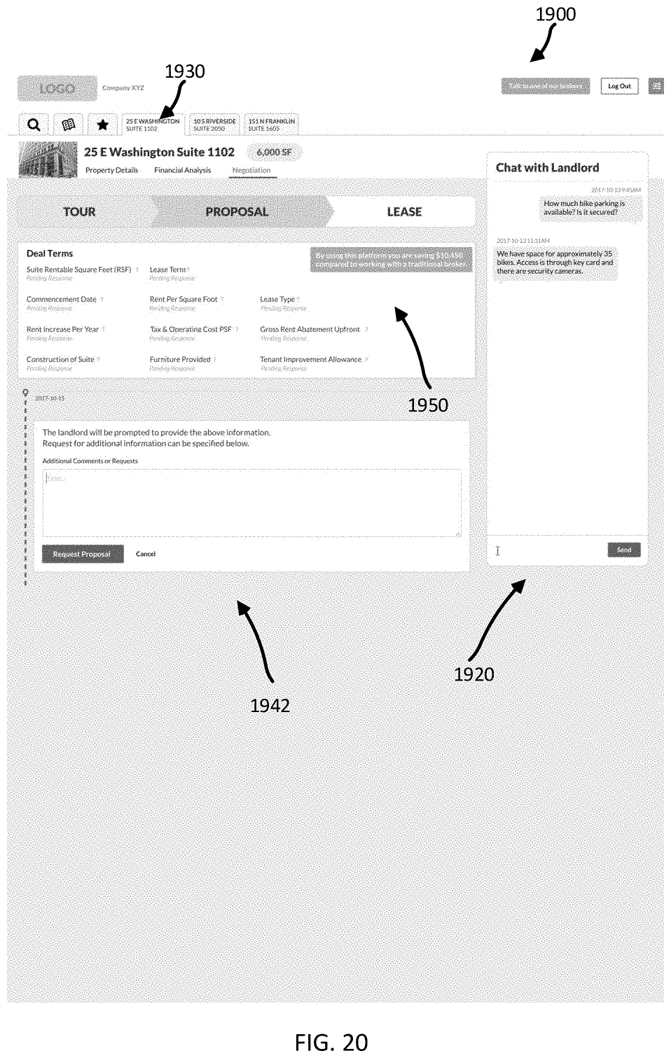

FIG. 20 shows a negotiation interface 1900 according to one example. In this example, the negotiation interface 1900 may include: a section 1920 that allows the user to chat with the landlord; a section 1930 that provides different tabs to access the “favorite” real estate properties; a section 1950 that displays the status of the displaying of the terms and a calculation of the amount of money saved by using the platform; and a section 1942 that allows the user to enter additional comments and requests and to request the proposal.

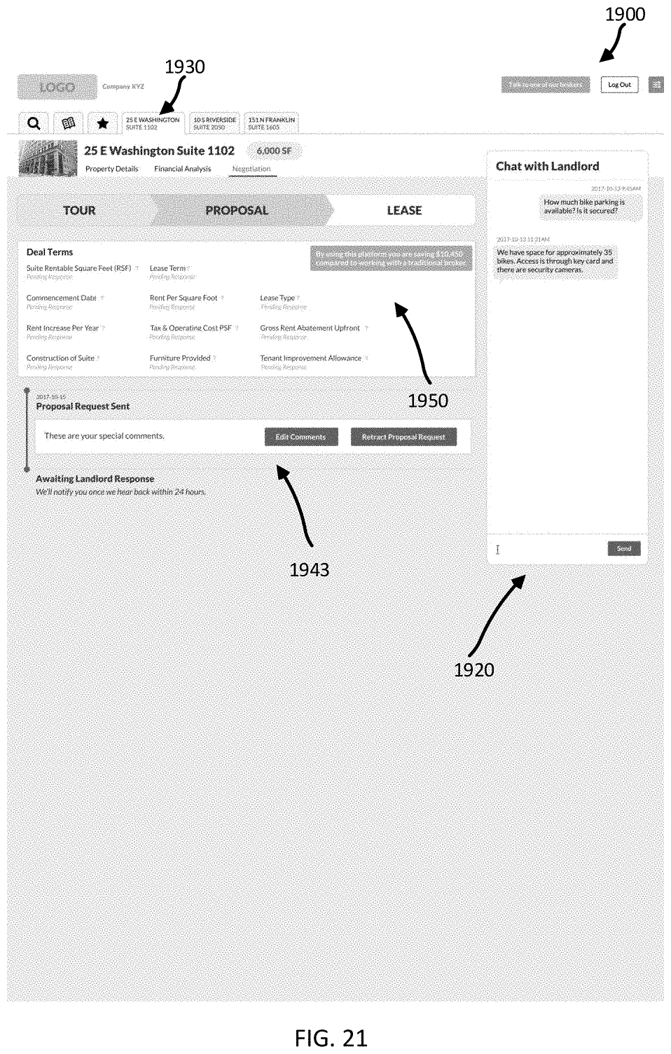

FIG. 21 shows a negotiation interface 1900 according to one example. In this example, the user is waiting for the response from the landlord. The negotiation interface 1900 may include: a section 1920 that allows the user to chat with the landlord; a section 1930 that provides different tabs to access the “favorite” real estate properties; a section 1950 that displays the status of the displaying of the terms and a calculation of the amount of money saved by using the platform; and a section 1943 that allows the user to edit comments and retract from the proposal request and shows the status of the landlord response.

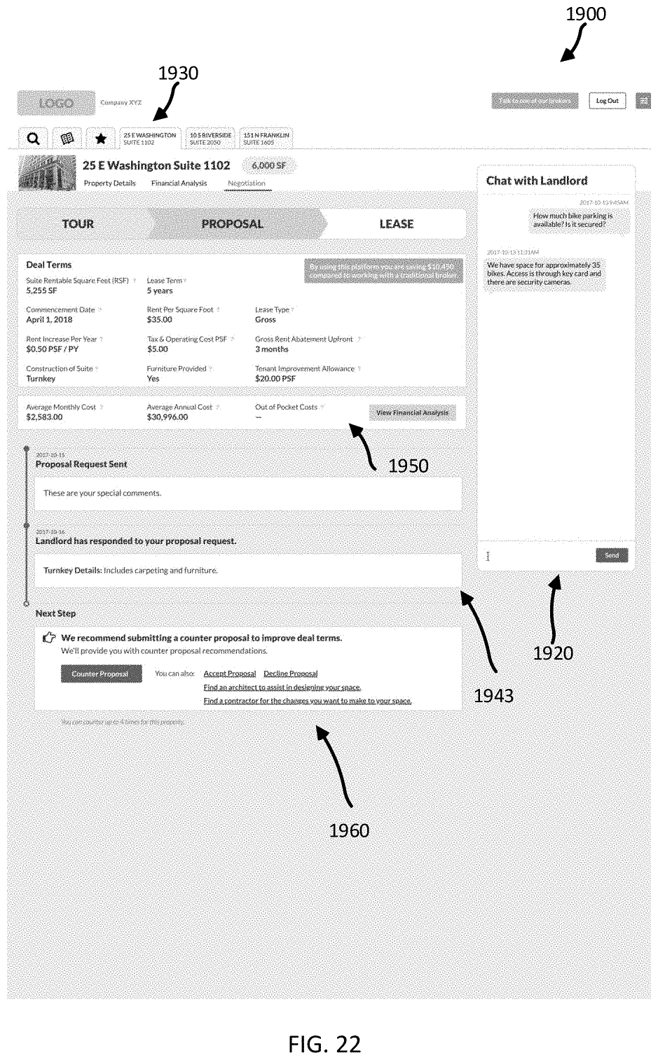

FIG. 22 shows a negotiation interface 1900 according to one example. In this example, the landlord has responded to the proposal. Thee negotiation interface 1900 may include: a section 1920 that allows the user to chat with the landlord; a section 1930 that provides different tabs to access the “favorite” real estate properties; a section 1950 that displays the terms of the proposal by the landlord; a section 1943 that allows the user to add comments and view comments from the landlord; and a section 1960 that provides buttons and controls to allow the user to counter the proposal, accept the proposal, decline the proposal, find an architect to assist in designing the space, and find a contractor for the changes the user wants to make to the space.

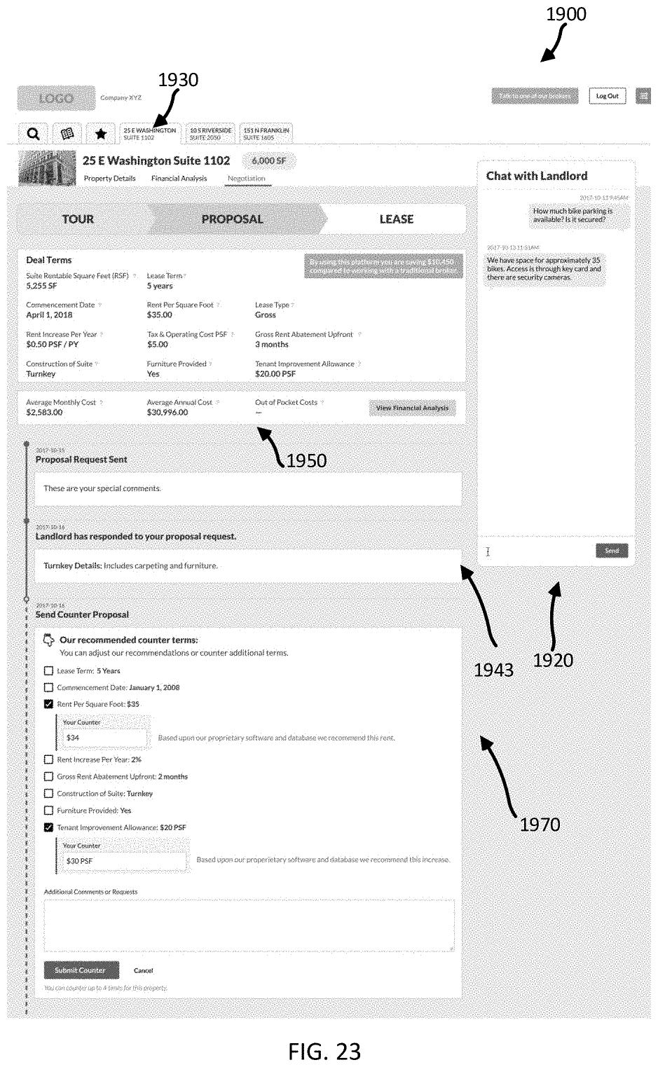

FIG. 23 shows a negotiation interface 1900 according to one example. In this example, the user has responded with a counter proposal. The negotiation interface 1900 may include: a section 1920 that allows the user to chat with the landlord; a section 1930 that provides different tabs to access the “favorite” real estate properties; a section 1950 that displays the terms of the proposal by the landlord; a section 1943 that allows the user to add comments and view comments from the landlord; and a section 1970 that provides suggestions on counter terms and counter term values. Section 1970 also may allow the user to enter the new term values and submit a counter proposal.

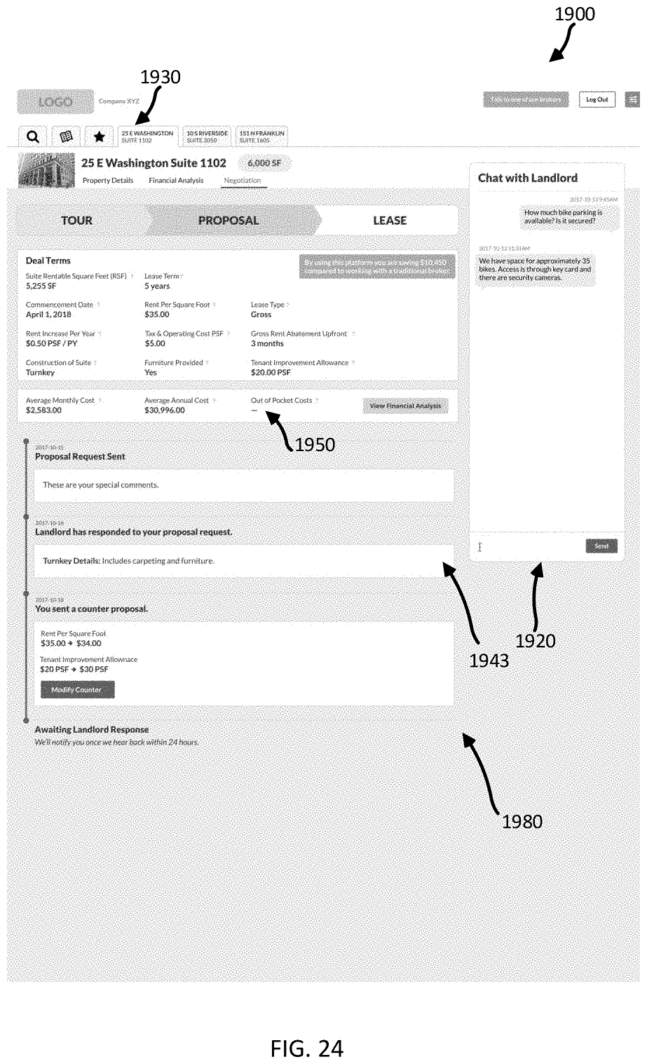

FIG. 24 shows a negotiation interface 1900 according to one example. In this example, the user is waiting for a landlord response. The negotiation interface 1900 may include: a section 1920 that allows the user to chat with the landlord; a section 1930 that provides different tabs to access the “favorite” real estate properties; a section 1950 that displays the terms of the proposal by the landlord; a section 1943 that allows the user to add comments and view comments from the landlord; and a section 1980 that shows that the user is waiting for the landlord response and information on the counter proposal price per square feet of the space.

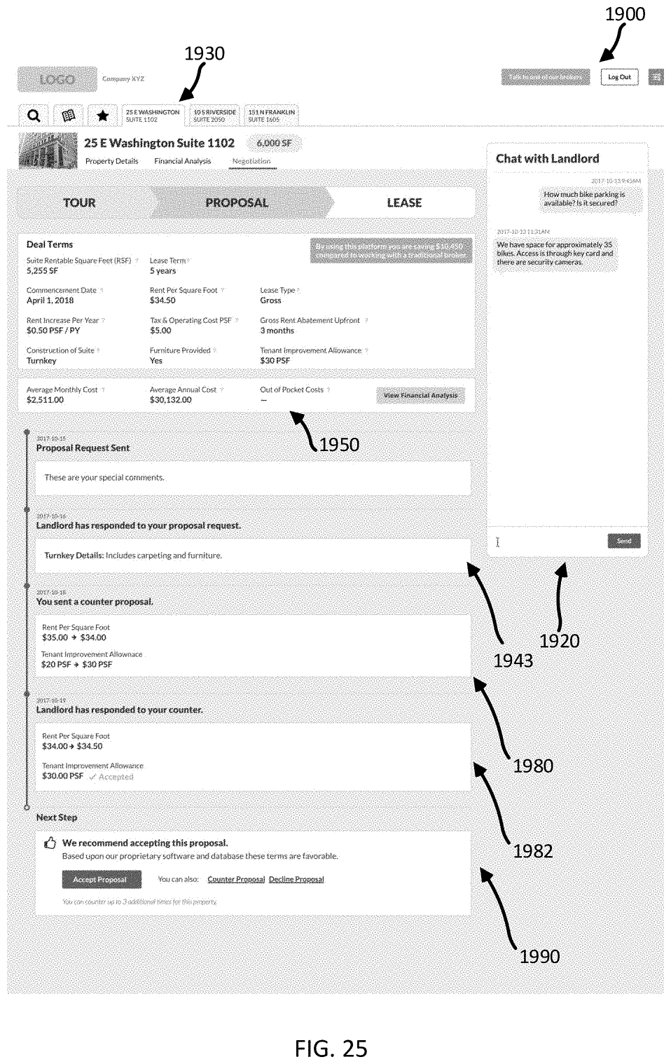

FIG. 25 shows a negotiation interface 1900 according to one example. In this example, the landlord has responded to the counter proposal. The negotiation interface 1900 may include: a section 1920 that allows the user to chat with the landlord; a section 1930 that provides different tabs to access the “favorite” real estate properties; a section 1950 that displays the terms of the proposal by the landlord; a section 1943 that allows the user to add comments and view comments from the landlord; a section 1980 that shows the counter proposal of the user; a section 1982 that shows that the landlord has responded to the counter proposal and information on the price per square feet of the space for the counter proposal of the landlord; and a section 1990 that provides buttons and controls to allow the user to accept the proposal, counter the proposal, or decline the proposal. The section 1990 may also display a recommendation stating whether to accept the proposal depending on if the terms are favorable to the user.

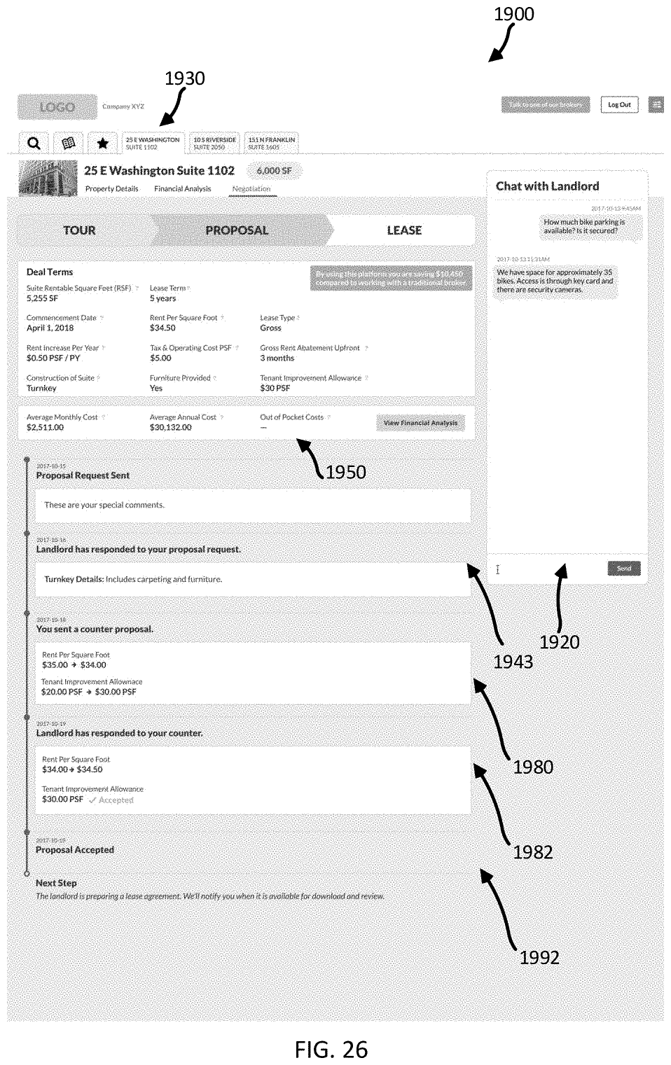

FIG. 26 shows a negotiation interface 1900 according to one example. In this example, the owner has accepted the counter proposal of the landlord. The negotiation interface 1900 may include: a section 1920 that allows the user to chat with the landlord; a section 1930 that provides different tabs to access the “favorite” real estate properties; a section 1950 that displays the terms of the proposal by the landlord; a section 1943 that allows the user to add comments and view comments from the landlord; a section 1980 that shows the counter proposal of the user; a section 1982 that shows that the landlord has responded to the counter proposal and information on the price per square feet of the space for the counter proposal of the landlord; and a section 1992 that displays that the proposal has been accepted.

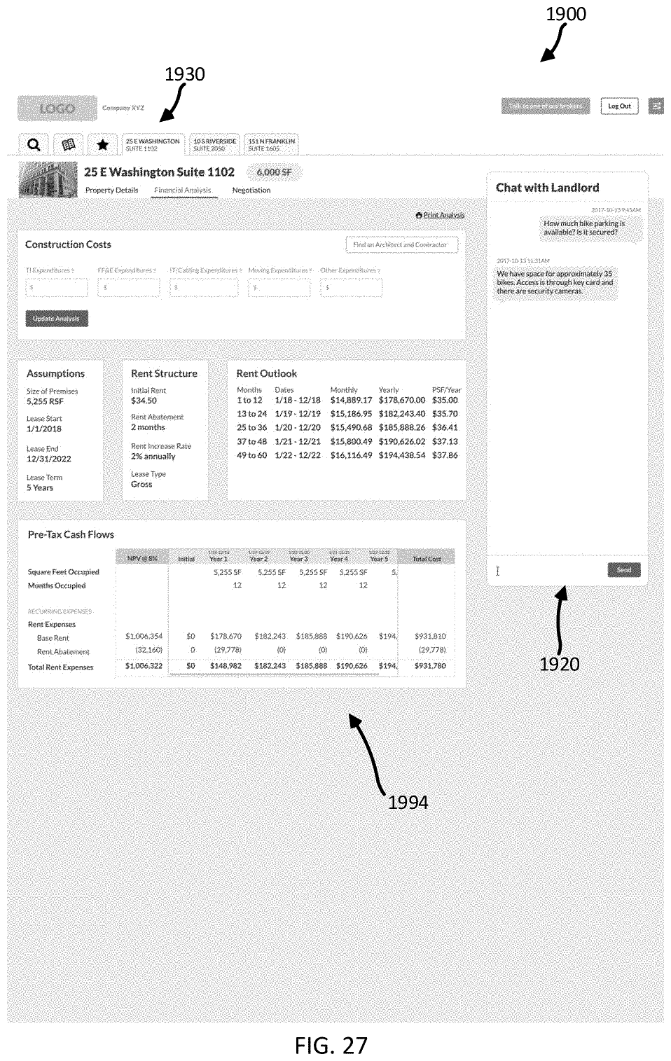

FIG. 27 shows a negotiation interface 1900 according to one example. In this example, the owner has requested a financial analysis. The negotiation interface 1900 may include: a section 1920 that allows the user to chat with the landlord; a section 1930 that provides different tabs to access the “favorite” real estate properties; and a section 1994 that contains the financial analysis.

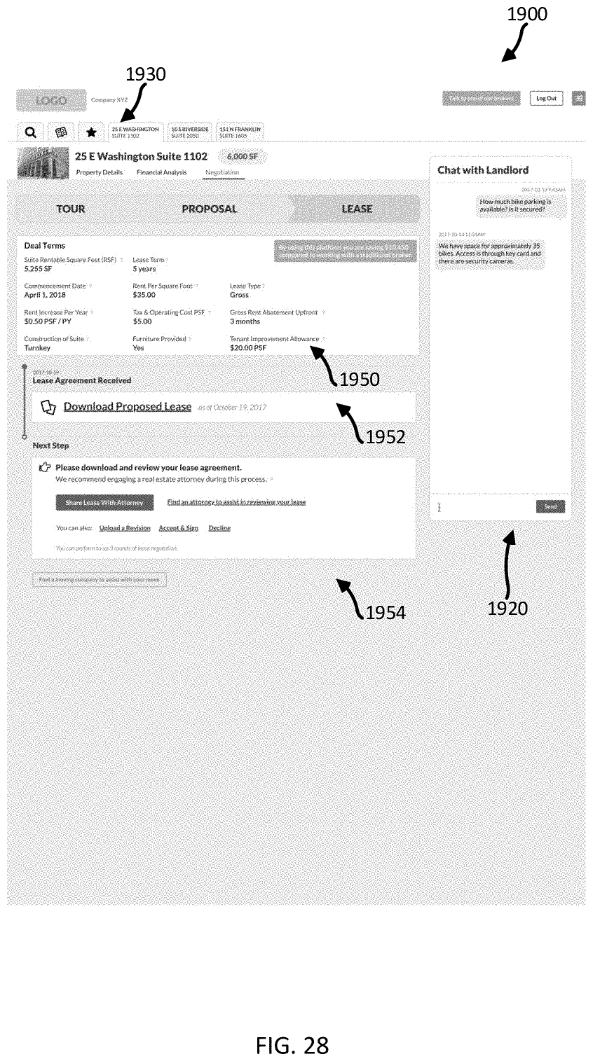

FIG. 28 shows a negotiation interface 1900 according to one example. In this example, the lease agreement has been received. The negotiation interface 1900 may include: a section 1920 that allows the user to chat with the landlord; a section 1930 that provides different tabs to access the “favorite” real estate properties; a section 1950 that displays the terms of the proposal by the landlord; a section 1952 that displays the current version of the proposed lease and allows the user to download the proposed lease; a section 1954 that provides buttons and controls that allows the user to share the lease with his attorney, find an attorney, upload a revision to the lease, accept and sign the lease, or decline the lease proposal.

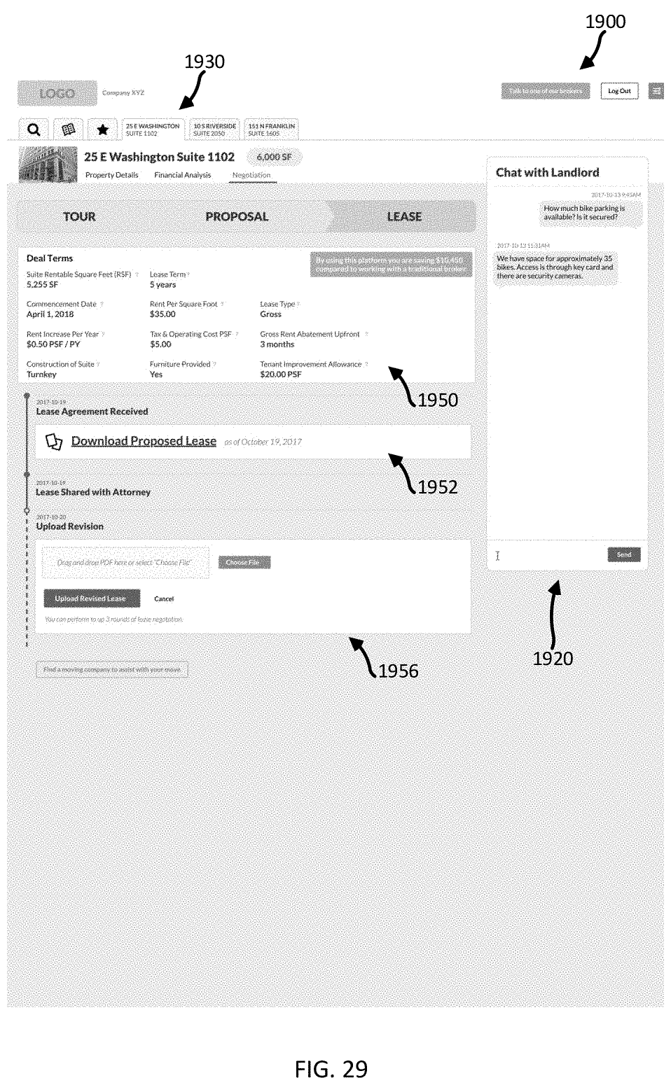

FIG. 29 shows a negotiation interface 1900 according to one example. In this example, the proposed lease is shared with the attorney. The negotiation interface 1900 may include: a section 1920 that allows the user to chat with the landlord; a section 1930 that provides different tabs to access the “favorite” real estate properties; a section 1950 that displays the terms of the proposal by the landlord; a section 1952 that displays the current version of the proposed lease and allows the user to download the proposed lease; and a section 1956 that shows that the lease has been shared with the attorney. Section 1956 may also provide buttons and controls to allow the user to upload a revised lease.

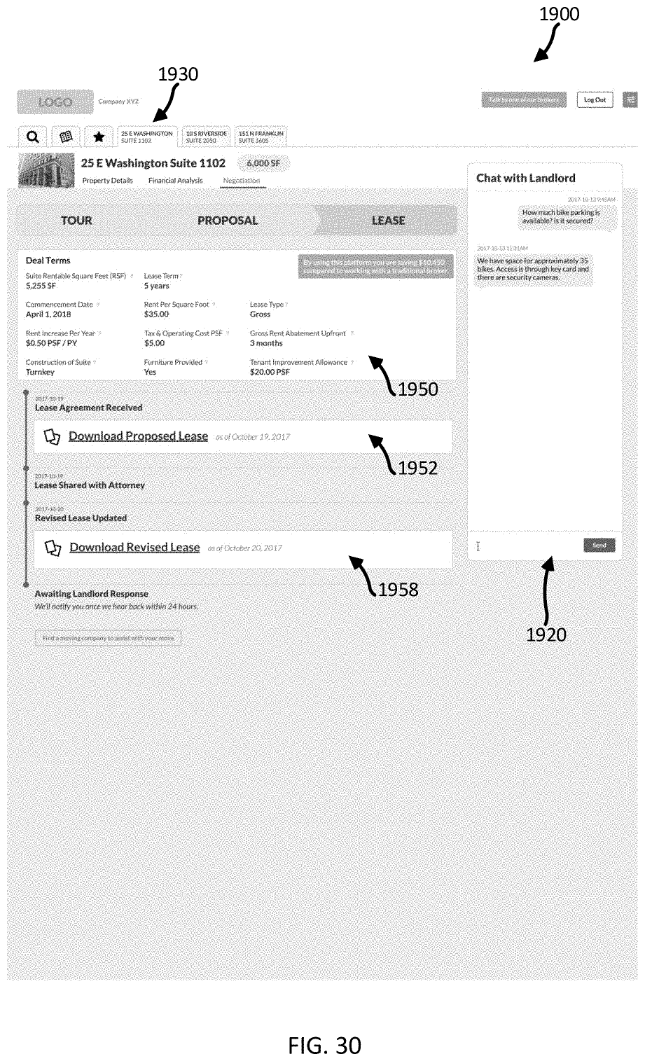

FIG. 30 shows a negotiation interface 1900 according to one example. In this example, the user is waiting for a landlord response. The negotiation interface 1900 may include: a section 1920 that allows the user to chat with the landlord; a section 1930 that provides different tabs to access the “favorite” real estate properties; a section 1950 that displays the terms of the proposal by the landlord; a section 1952 that displays the original version of the proposed lease and allows the user to download the proposed lease; and a section 1958 that allows the user to download or upload a revised version of the lease.

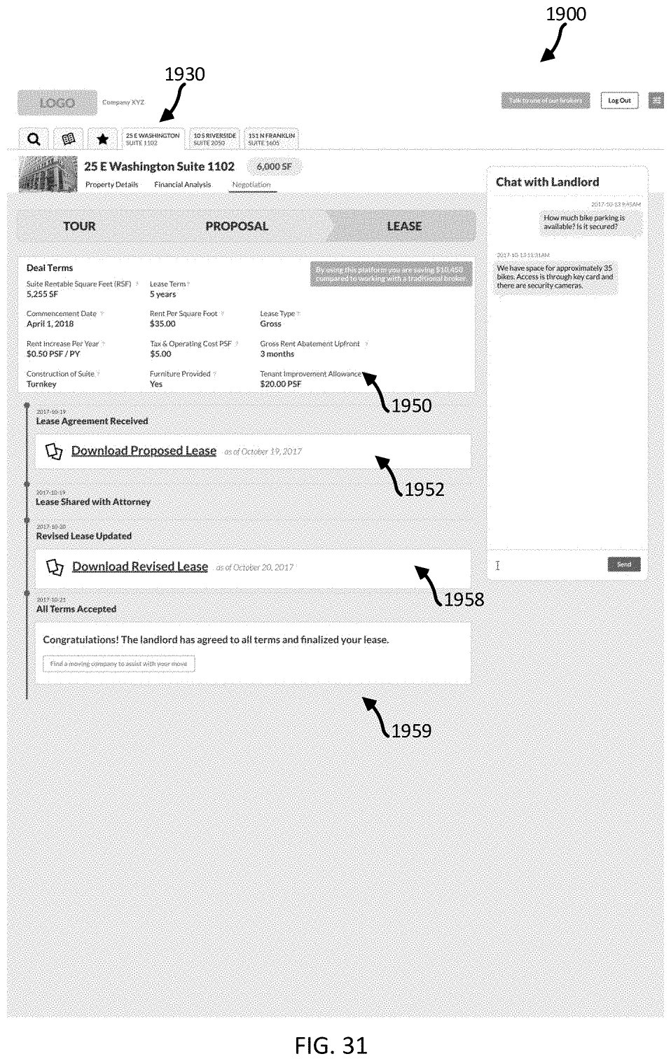

FIG. 31 shows a negotiation interface 1900 according to one example. In this example, the landlord accepts all the terms of the lease. The negotiation interface 1900 may include: a section 1920 that allows the user to chat with the landlord; a section 1930 that provides different tabs to access the “favorite” real estate properties; a section 1950 that displays the terms of the proposal by the landlord; a section 1952 that displays the original version of the proposed lease and allows the user to download the proposed lease; a section 1958 that allows the user to download a revised version of the lease; and a section 1959 that shows that the landlord has accepted. The section 1959 also provides a button for the user to find a moving company to assist with the move.

In any one or more of the above disclosed display screens and/or modules, the user or another party using the system may change one or more fields to alter the data and calculations according to their needs or preferences. The users can thus manipulate the modules, displays, and/or screens during the back and forth transaction among the parties. The system thus allows streamlined back and forth communication and negotiation among the various parties to the transaction. This saves significant time and reduces the number of existing procedural steps and separate communications that are now necessary to complete these types of difficult transactions. Further, the disclosed system can eliminate difficulties that currently exist with trying to contact and communicate with multiple parties to exchange information and arrange for viewings, negotiations, meetings, and the like.

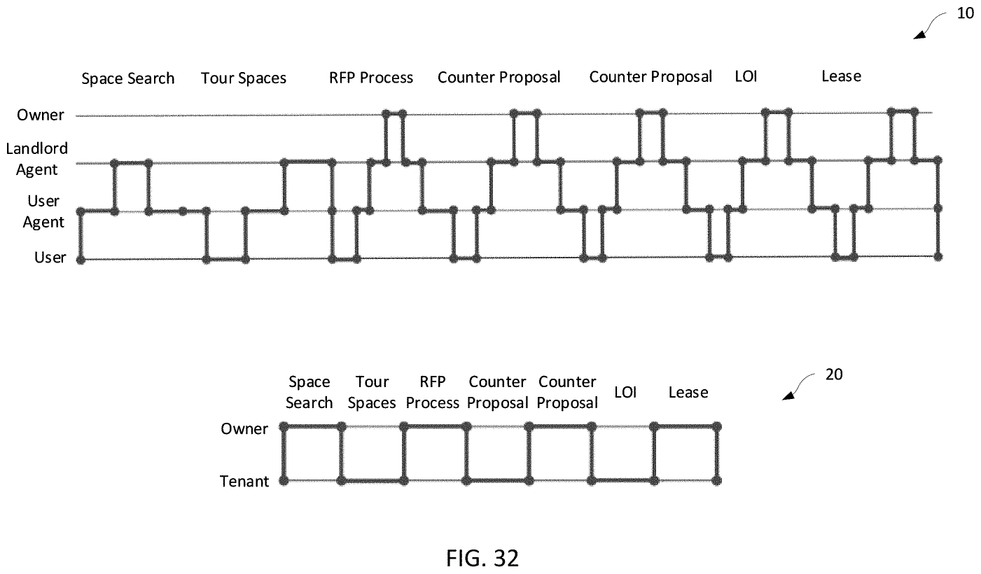

FIG. 32 depicts an example of a direct negotiation between the user and owner, thus eliminating their respective representatives (User Agent and Landlord/Owner Agent). Due to a direct line of communication, the information is delivered instantly, rather than a typical path where the information is sent to the representatives, sometimes delaying the process by days or weeks. The agents may be involved, but the information can flow directly from the user to the owner, which provides transparency and time savings.

As illustrated in FIG. 3, the computer 124 may include a processor 110, e.g., a central processing unit (CPU), a graphics processing unit (GPU), or both. The processor 110 may be a component in a variety of systems. For example, the processor 110 may be part of a standard personal computer or a workstation. The processor 110 may be one or more general processors, digital signal processors, application specific integrated circuits, field programmable gate arrays, servers, networks, digital circuits, analog circuits, combinations thereof, or other now known or later developed devices for analyzing and processing data. The processor 110 may implement a software program, such as code generated manually (i.e., programmed).

The computer 124 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, content addressable memory, flash memory, magnetic tape or disk, optical media and the like. In one embodiment, the memory 304 includes a cache or random-access memory for the processor 110. In alternative embodiments, the memory 304 is separate from the processor 110, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 110. The functions, acts or tasks illustrated in the figures or described herein may be performed by the programmed processor 110 executing the instructions 312 stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer 124 may further include a display unit 314, such as a liquid crystal display (LCD), an organic light emitting diode (OLED), a flat panel display, a solid state display, a cathode ray tube (CRT), a projector, a printer or other now known or later developed display device for outputting determined information. The display 314 may act as an interface for the user to see the functioning of the processor 110, or specifically as an interface with the software stored in the memory 304 or in the drive unit 306.

Additionally, the computer 124 may include an input device 316 configured to allow a user to interact with any of the components of system 100. The input device 316 may be a number pad, a keyboard, or a cursor control device, such as a mouse, or a joystick, touch screen display, remote control or any other device operative to interact with the system 100.

In a particular embodiment, as depicted in FIG. 3, the computer 124 may also include a disk or optical drive unit 306. The disk drive unit 306 may include a computer-readable medium 310 in which one or more sets of instructions 312, e.g. software, can be embedded. Further, the instructions 312 may embody one or more of the methods or logic as described herein. In a particular embodiment, the instructions 312 may reside completely, or at least partially, within the memory 304 and/or within the processor 110 during execution by the computer 124. The memory 304 and the processor 110 also may include computer-readable media as discussed above.

The present disclosure contemplates a computer-readable medium that includes instructions 312 or receives and executes instructions 312 responsive to a propagated signal, so that a device connected to a network 127 can communicate voice, video, audio, images or any other data over the network 127. Further, the instructions 312 may be transmitted or received over the network 127 via a communication interface 318. The communication interface 318 may be a part of the processor 110 or may be a separate component. The communication interface 318 may be created in software or may be a physical connection in hardware. The communication interface 318 is configured to connect with a network 127, external media, the display 314, or any other components in system 100, or combinations thereof. The connection with the network 127 may be a physical connection, such as a wired Ethernet connection or may be established wirelessly as discussed below. Likewise, the additional connections with other components of the system 100 may be physical connections or may be established wirelessly.

The network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

In accordance with various embodiments of the present disclosure, the methods described herein may be implemented by software programs executable by a computer system. Further, in a non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the disclosure is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single-medium or multiple-media, such as a centralized or distributed database, and/or associated caches and servers that store one or more sets of instructions. The term “computer-readable medium” shall also include any medium that can store, encoding or carrying a set of instructions for execution by a processor or that cause a computer system to perform any one or more of the methods or operations disclosed herein.

In a non-limiting, embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

Although certain systems, platforms, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A web or app based real estate system or platform, the system comprising:
a processor and a memory coupled therewith; and
a computer executable program code stored in the memory and executable by the processor to generate,
a tenant module to allow a user to sign up for a real estate service and/or to perform a search of the real estate property,
a space search module to perform a search of a real estate property,
a touring module to schedule a tour and/or to perform a tour,
a negotiation module to negotiate a proposal,
a landlord module,
a space requirements calculation module, executed by the processor, wherein the space requirements calculation module allows the user to enter default settings data for a space, and
a user interface, which includes,
a tenant interface, executed by the processor, controlled by a prospective tenant for allowing the prospective tenant to connect to the tenant module and thereby enter tenant information into the tenant module,
a landlord interface, executed by the processor, controlled by a landlord for connecting to the landlord module and thereby identify the real property and identify the real estate property based on space characteristics, and
a broker interface, executed by the processor, controlled by a broker for connecting to the broker module,
wherein the space requirements calculation module calculates a general square foot number based upon data to determine how much space to search for.

2. The system of claim 1, configured for matching a prospective tenant with a real estate property owned by a landlord, or managed by a property management company or realtor, at least in part based on a space requirement calculation.

3. The system of claim 2, wherein the matching is further based on geographic location and price based upon data entered by the user for a space.

4. The system of claim 1, wherein the interface system is displayed in a web interface.

5. A computer implemented method for matching a prospective tenant with a real estate property owned by a landlord or managed by a property management company or realtor, at least in part based on a space requirement calculation, the method comprising:
allowing a user, by a computer, to evaluate the amount of space required for a real state property;
allowing a user, by a computer, to search for the real estate property;
scheduling, using input data of a user, by a computer, a tour of the real estate property;
negotiating, using the input data of a user, by a computer, for a space with input from a computer;
agreeing, by a computer to the terms; and
finalizing, by a computer, a lease for the lease.

6. The method of claim 5, wherein the negotiating includes:
sending a request for the proposal;
receiving a proposal from the corresponding landlord; and
sending a counter proposal.

7. The method of claim 6, wherein the negotiating further includes:
receiving a counter proposal; and
submitting a revised offer.

8. The method of claim 7, further including agreeing to terms of a lease.

9. A method implemented by a computer system for web-based interaction to match a prospective tenant with a real estate property from a plurality of real estate properties, the method comprising:
creating, by a processor of the computer system, a real estate database of information related to the plurality of real estate properties, the database created from information acquired from a landlord, the information including real estate data for the plurality of real estate properties;
displaying, by a processor of the computer system via a user interface presented to the user on a display coupled to a client computer, a display of real estate parameters;
receiving, from the client computer, an input data of the real estate parameters provided by the user via the user interface indicating a request for real estate information;
performing, by the processor, a space requirements calculation based on the input data;
performing, by the processor, a space search on the real estate database based on the space requirements calculation;
displaying, by the processor, via the user interface, a display of a subset of the plurality of real estate properties that match the space search;
setting up the tour of real estate properties; and
negotiating a proposal.

10. The method of claim 9, wherein the setting up the tour of real estate properties comprises:
receiving, from the client computer, user input data indicating a request for the tour;
requesting, from a landlord, landlord input data indicating acceptance of the request of the tour;
creating, by the processor, a tour data display using the data input by the landlord;
sending, by the processor, the tour data display to the client computer that requested the tour data display;
displaying, by the processor, the tour data display.

11. The method of claim 9, wherein the negotiating the proposal comprises:
receiving, from the client computer, user input data indicating the request for the proposal;
requesting, from a landlord, landlord input data indicating the terms of the proposal;
displaying, by the processor, the terms of the proposal display;
receiving, from the client computer, user input data indicating a counter proposal; and
requesting, from a landlord, landlord input data indicating acceptance to the terms of the counter proposal.
